(19) United States
(12) Patent Application Publication
(10) Pub. No.: US 2008/0152989 A1
(43) Pub. Date: Jun. 26, 2008

(54) FUEL CELL MODULE

(75) Inventors: Jer-Nan Yeh, Kaohsiung City (TW); Huan-Ruei Shiu, Penghu County (TW); Yi-Yie Yan, Hsinchu City (TW); Tien-Tung Chung, Taipei City (TW); Jian-Gou Peng, Taipei City (TW)

Correspondence Address: QUINTERO LAW OFFICE, PC, 2210 MAIN STREET, SUITE 200, SANTA MONICA, CA, 90405, US

(73) Assignee: Industrial Technology Research Institute, Hsinchu (TW)

(21) Appl. No.: 11/745,349

(22) Filed: May 7, 2007

(30) Foreign Application Priority Data
Dec. 21, 2006 (TW) 95148151

(51) Int. Cl. H01M 2/00

(52) U.S. Cl. 429/34

(57) ABSTRACT

A fuel cell module. The fuel cell module includes two end plates, a fuel-cell set, at least one fixing member, and at least one compressing member. The two end plates have an inner portion and an outer portion, respectively. The outer portion surrounds the inner portion. The fuel set, abutting the inner portion, is disposed between the two end plates. The fixing member fixes the fuel-cell set between the two end plates. The compressing member, disposed on the outer portion, applies a first force to the outer portion.

### BACKGROUND OF THE INVENTION

1. Field of the Invention

The invention relates to a fuel cell module, and in particular, to a fuel cell module with strong impermeability and sturdy structure.

2. Description of the Related Art

Referring to FIG. 1A, a conventional fuel cell module 10 comprises two end plates 11 and several fuel cells. The fuel cells are stacked in series to form a fuel-cell set 12 between the end plates 11. A screw 131 passes through the end plates 11 and the fuel-cell set 12 and connects with the nuts 132 to fix the fuel-cell set 12. However, fixing from the circumference of the end plates 11 causes the end plates 11 to deform (as shown in FIG. 1B). Therefore, the force is only applied to the circumference of the fuel-cell set 12, and the centre portion of the fuel-cell set 12 receives insufficient force. If the force applied to the fuel-cell set 12 is unevenly distributed, the impermeability and the integrity of the overall structure can be affected.

Referring to FIG. 2, another conventional fuel cell module 20 is provided, utilizing an elastic material 24 between the end plates 21 and the fuel-cell set 22. A lock member 23 is provided to fix the end plates 21 and the fuel-cell set 22. In this case, the elastic member 24 is located in the centre portion of the fuel-cell set 22 to help balance force applied on the fuel cell module.

FIG. 3 depicts another conventional fuel cell module 30. An upper plate 341 and a plurality of screws 342 are added to the fuel cell module 30 with fuel-cell set 32 is disposed between the upper end plate 311 and the lower end plate 312, and the upper plate 341 is disposed above the upper end plate 311. A lock member 33 fixes the upper plate 341, the upper end plate 311, the fuel-cell set 32 and the lower end plate 312. The plurality of screws 342, abutting the center portion of the upper end plate 311, is rotatably disposed on the upper plate 341. By rotation of the screws 342, force is applied to the center portion of the upper end plate 311 to help balance the force applied on the fuel cell module.

However, addition of an elastic member between the end plates and the fuel-cell set requires other adjustments of the design, such as of the air inlet/outlet and the water inlet/outlet on the end plates, increasing costs. Additionally, the conventional fuel cell modules described both apply force on the center portion of the end plate(s) to minimize the deformation of the end plates. Not only are additional complicated elements required, but the structure must further be changed, decreasing economic efficiency.

### BRIEF SUMMARY OF THE INVENTION

The invention provides a fuel cell module. The fuel cell module includes two end plates, a fuel-cell set, at least one fixing member, and at least one compressing member. The two end plates have an inner portion and an outer portion, respectively. The outer portion surrounds the inner portion. The fuel set, abutting the inner portion, is disposed between the two end plates. The fixing member fixes the fuel-cell set between the two end plates. The compressing member, disposed on the outer portion, applies a first force to the outer portion.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a side view of a conventional fuel cell module;

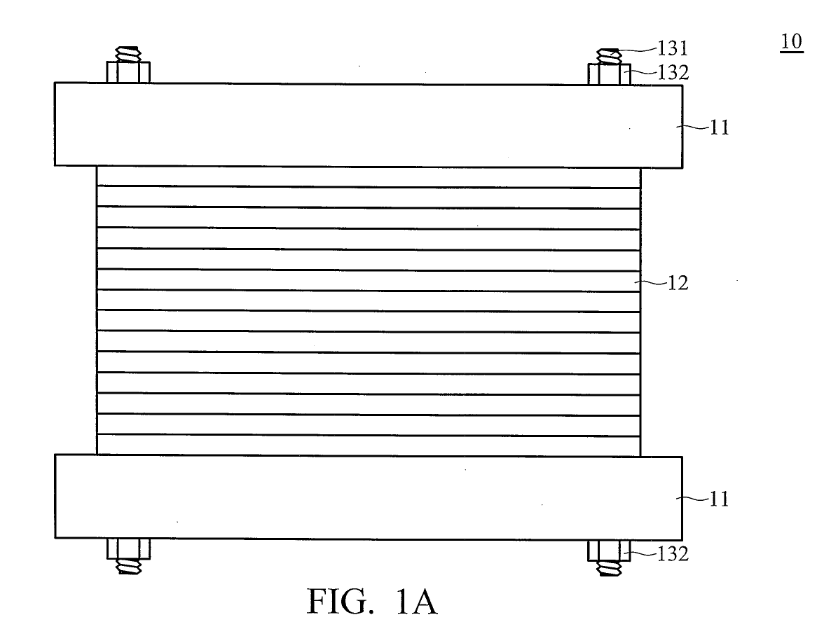

FIG. 1B is a side view of the fuel cell module in FIG. 1A after deformation;

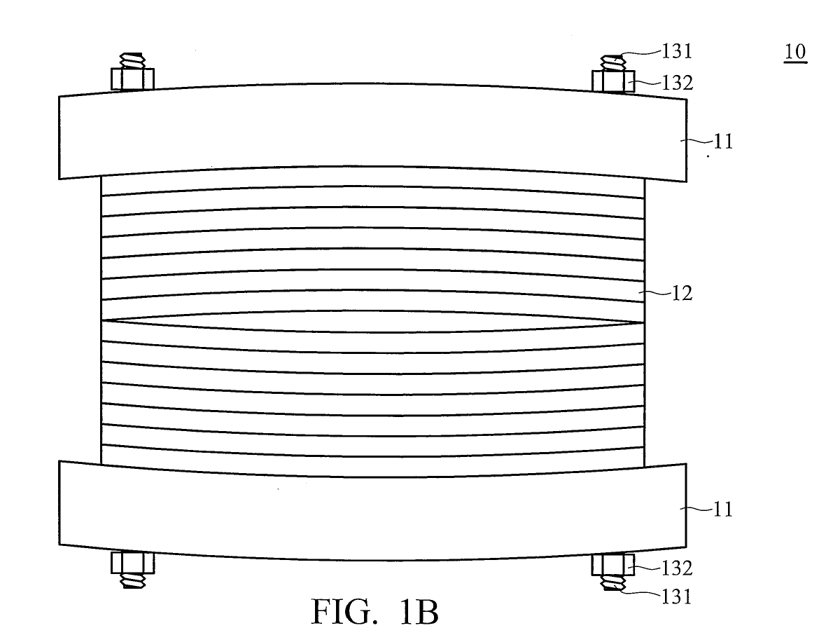

FIG. 2 is a sectional view of another conventional fuel cell module;

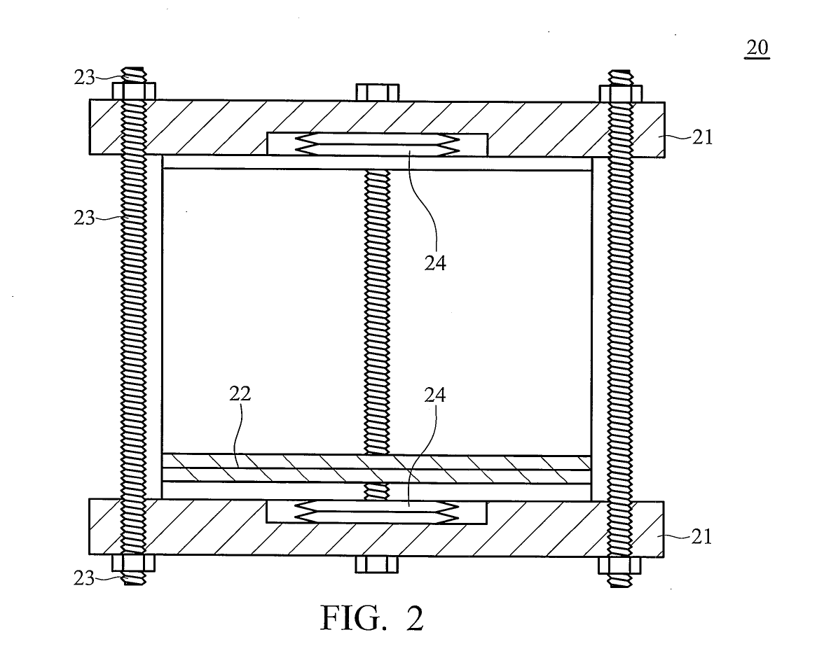

FIG. 3 is a side view of another conventional fuel cell module;

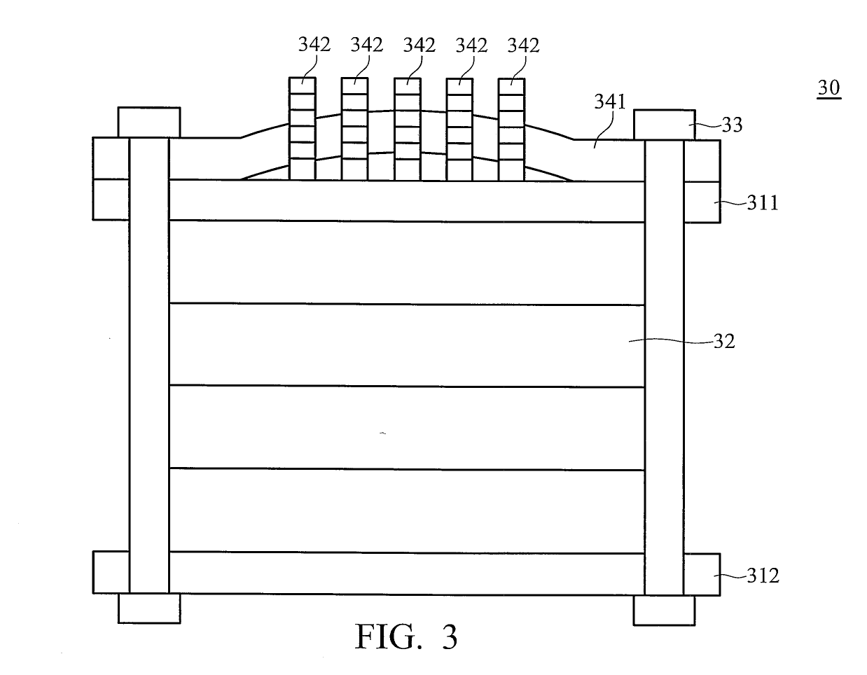

FIG. 4A is a top view of a fuel cell module of the invention;

FIG. 4B is a sectional view along line A-A of the fuel cell module in FIG. 4A; and

FIG. 5 is a sectional view of a variant embodiment of the fuel cell module of the invention.

### DETAILED DESCRIPTION OF THE INVENTION

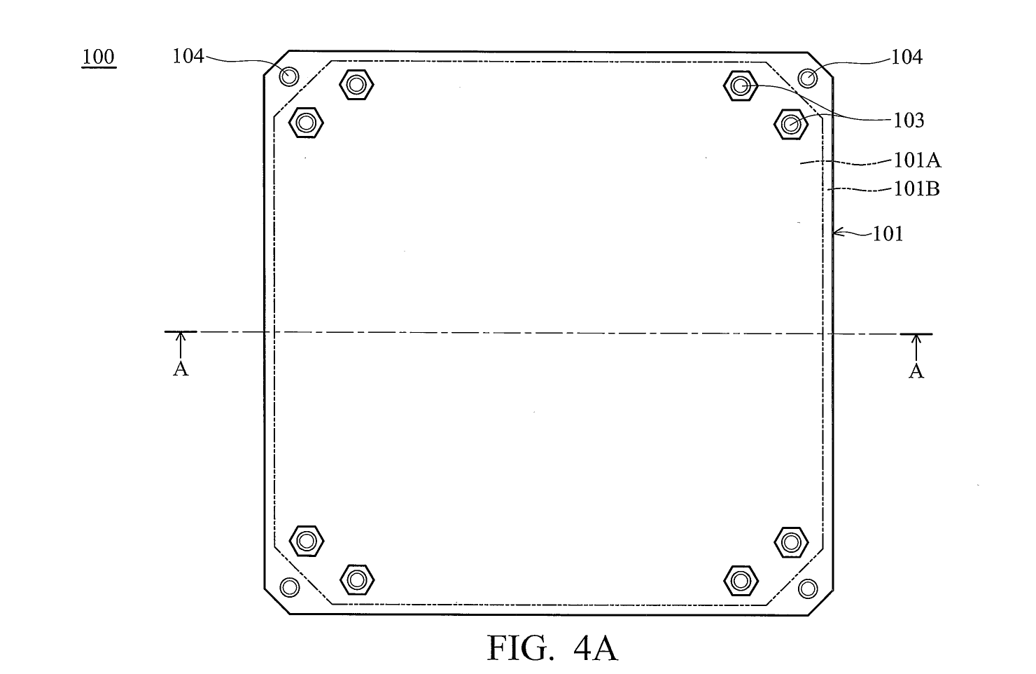

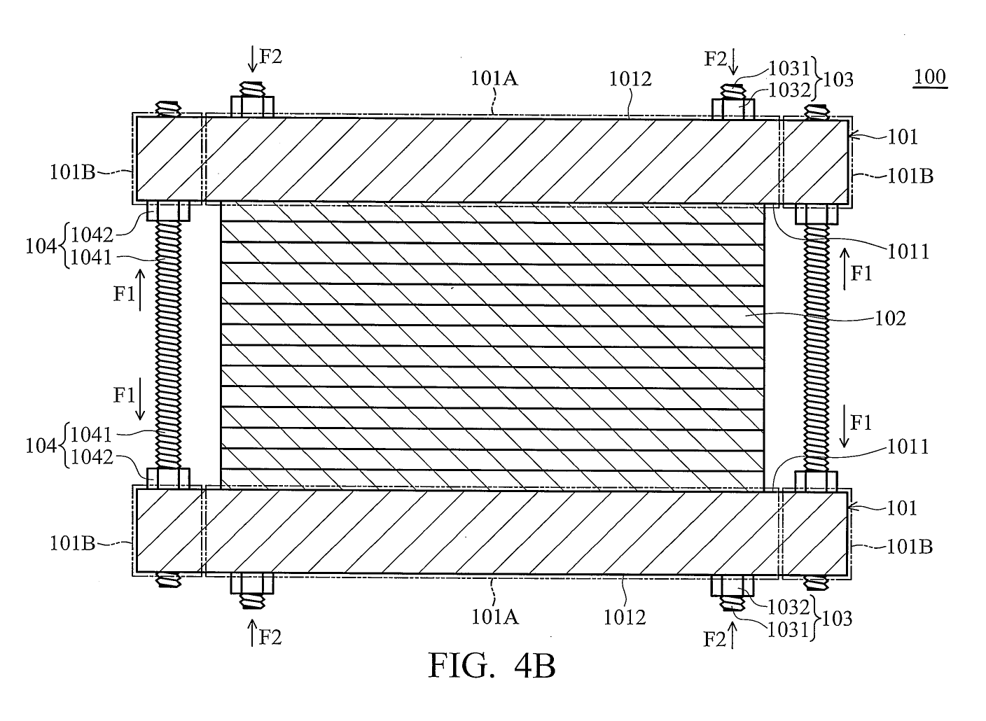

Referring to FIGS. 4A and 4B, a fuel cell module 100 is provided, comprising two end plates 101, a fuel-cell set 102, eight fixing member 103 and four compressing members 104.

The end plate 101 is rectangular, and has four corners, an inner portion 101A, an outer portion 101B, a first surface 1011 and a second surface 1012. The outer portion 101B surrounds the inner portion 101A. The first surfaces 1011 of the two end plates 101 face each other. The second surface 1012 is opposite to the first surface 1011.

The fuel-cell set 102, comprising a plurality of fuel cells, is disposed between the first surfaces 1011 of the two end plates 101. The fuel-cell set 102 abuts the first surfaces 1011 of the two end plates 101, respectively.

Each fixing member 103, disposed on the inner portions 101A of the two end plates 101, comprises a first screw 1031 and two first nuts 1032. The first screw 1031 passes through the two end plates 101 and the fuel-cell set 102. Two ends of the first screw 1031 connect with the nuts 1032 at the second surfaces 1012 of the two end plates 101, respectively.

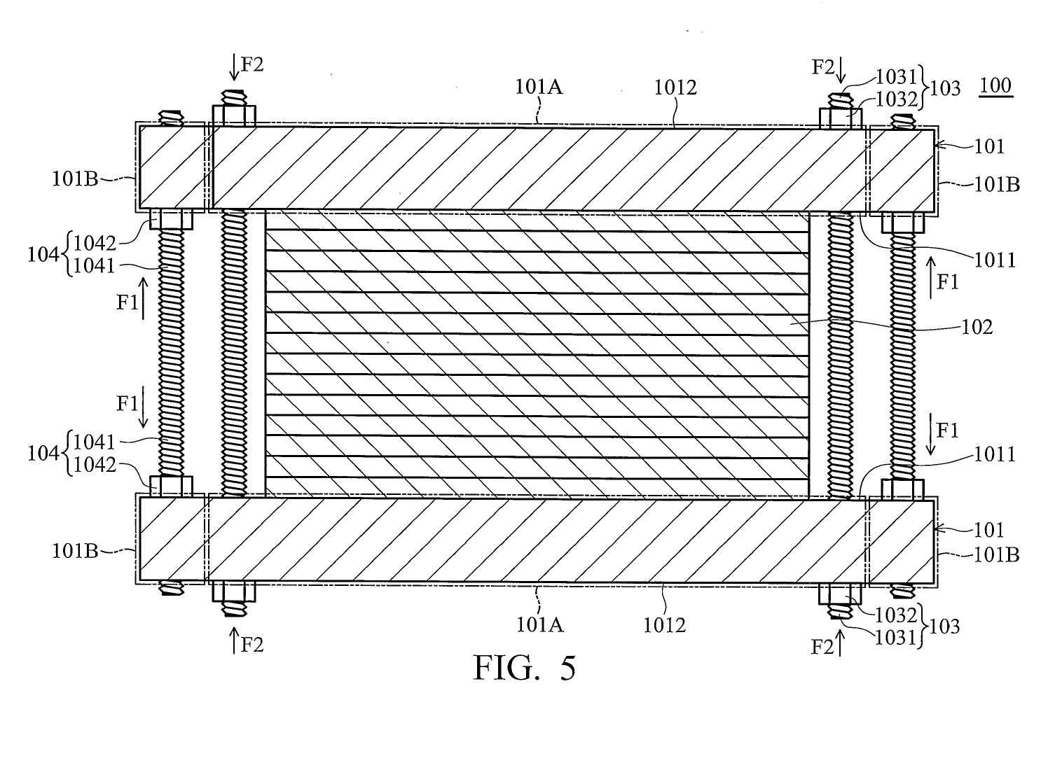

It should be noted that while the fixing members 103 are disposed on the inner portions 101A of the end plates 101 in the embodiment, they are not limited thereto, and can alternatively be disposed on the outer portions 101B of the end plates 101, passing through the end plates 101 thereby. Two ends of the first screw 1031 then connect with the nuts 1032 at the second surfaces 1012 of the two end plates 101, respectively (as shown in FIG. 5).

The compressing members 104 are disposed on the outer portions 101B of the two end plates 101. The four compressing members 104 are respectively located on the four corners of the end plates 101. Each compressing member 104 comprises a second screw 1041 and two second nuts 1042. Two ends of the second screw 1041 are respectively disposed on the two end plates 101. The two second nuts 1042, respectively abutting the first surfaces 1011 of the two end plates 101, are movably disposed on the second screw 1041.

Referring to FIGS. 4A and 5, adjustment of position of the second nuts 1042 towards the end plates 101 allows the second nuts 1042 to apply a first force F1 to the end plates 101. The two ends of the first screw 1031 connect with the first nuts 1032 at the second surface 1012, providing a second force F2 to the end plates 101. It is noted that the first force F1 has a direction opposite to that of the second force F2, minimizing the deformation of the end plates 101 caused by the fixing member 103.

The fuel cell module 100 of the invention provides a disposition of the compressing elements 1041 on the outer portions 101B of the end plates 101 to balance the force applied on the fuel cell module 100, and in addition to improve the overall efficiency. In the embodiment, the first screw 1031, the first nuts 1032 of the fixing member 103 are the same as the second screw 1041, the second nuts 1042 of the compressing member 104. Compared to the conventional fuel cell module, additional design requirements and manufacturing cost, such as compressing members 104, are reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell module, comprising:
two end plates, having an inner portion and an outer portion, respectively, the outer portion surrounding the inner portion;
a fuel-cell set disposed between the two end plates, abutting the inner portion;
at least one fixing member, fixing the fuel-cell set between the two end plates; and
at least one compressing member disposed on the outer portion, applying a first force on the outer portion.

2. The fuel cell module as claimed in claim 1, wherein the fixing member applies a second force to the two end plates, and direction of the first force is opposite to the direction of the second force.

3. The fuel cell module as claimed in claim 1, wherein each of the end plates has a first surface and a second surface, the second surface is opposite to the first surface, and the first surfaces of the two end plates face each other.

4. The fuel cell module as claimed in claim 3, wherein the fixing member comprises a first screw and two first nuts, the first screw passing through the end plates and the fuel-cell set, connecting to the first nuts at the second surfaces of the end plates, respectively.

5. The fuel cell module as claimed in claim 3, wherein the fixing member comprises a first screw and two first nuts, the first screw passing through the end plates, connecting the first nuts at the second surfaces of the end plates, respectively.

6. The fuel cell module as claimed in claim 3, wherein the compressing member comprises a second screw and two second nuts, the second screw is disposed on the two end plates, and the second nuts, movably disposed on the second screw, abut the first sides of the two end plates.

7. The fuel cell module as claimed in claim 1, wherein the two end plates are rectangular and have four corners, and when multiple compressing members are present, the compressing members are disposed at the four corners of the two end plates.

8. The fuel cell module as claimed in claim 1, wherein multiple fixing members are disposed in the inner portion.

9. The fuel cell module as claimed in claim 1, wherein multiple compressing members are disposed on the outer portion.

10. The fuel cell module as claimed in claim 1, wherein the fuel-cell set comprises a plurality of fuel cells.
